(19) United States
(12) Patent Application Publication
(10) Pub. No.: US 2016/0212197 A1
(43) Pub. Date: Jul. 21, 2016

(54) MULTICAST DELIVERY

(71) Applicant: TELEFONAKTIEBOLAGET LM ERICSSON (PUBL), Stockholm (SE)

(72) Inventors: Mats Cedarvall, Harnosand (SE); René Dekker, Stockholm (SE); Joacim Halén, San Jose, CA (US); Ignacio Más Ivars, Tullinge (SE); Fredrik F. Persson, Alvsjo (SE)

(21) Appl. No.: 15/083,864

(22) Filed: Mar. 29, 2016

Related U.S. Application Data
(63) Continuation of application No. 12/303,211, filed on Dec. 3, 2008, now abandoned.
(60) Provisional application No. 60/803,729, filed on Jun. 2, 2006.

(51) Int. Cl. H04L 29/08; H04L 12/18

(52) U.S. Cl. CPC H04L 67/06; H04L 12/18

(57) ABSTRACT

A method and nodes in a communication network for controlling multi-cast delivery of files, wherein the multi-cast delivery is adapted to reduce the amount of required uni-cast file deliveries in the communication network. A browser of an IPTV Terminating Function requiring a file interrogates a cache of the IFT for the file content before a uni-cast request for file delivery is sent to an Application Service Platform. The files stored in the cache have been previously delivered to the IFT via the proposed multi-cast mechanism. If the file content is not stored in the cache, a uni-cast request is sent to the ASP. Each uni-cast request is also forwarded to a Multi-Cast Controller, which determines whether the requested file should be sent also to a plurality of additional IFTs on a multi-cast channel. At each IFT, listening to the multi-cast channel, the received content can be handled selectively according to a filtering mechanism, and a received file may, e.g. be stored in the cache for later retrieval.

This application is a continuation of co-pending U.S. patent application Ser. No. 12/303,211 filed Dec. 3, 2008, which was the National Stage of International Application No. PCT/SE2007/000534, filed Jun. 1, 2007, which claims the benefit of U.S. Provisional Application 60/803,729, filed on Jun. 2, 2006, the entire teachings of which are hereby incorporated by reference.

### TECHNICAL FIELD

The present invention relates generally to a method and arrangement for providing an efficient delivery mechanism for delivery of file content over a multi-cast channel, and for providing for flexible reception and handling of the content at the receiving ends.

### BACKGROUND

IPTV is an emerging technique for delivery of broadcasted TV services over an IP network. The predominant IPTV service is Broadcast TV, wherein the normal non-IPTV channels, as well as additional channels with low penetration are transmitted over a broadband network from a super head-end to a plurality of end-users, typically having a set-top-box (STB).

In traditional broadcast TV systems, such as e.g. Digital Video Broadcasting-Terrestrial (DVB-T) and Digital Video Broadcasting-Satellite (DVB-S), a broadcast channel is dedicated to transmit/receive application layer information. Application layer information may comprise e.g. an Electronic Program Guide (EPG), which is an on-screen guide to scheduled broadcast television programs, allowing a viewer to navigate, select, and discover content by time, title, channel, genre, etc, by use of, e.g. a remote control, a keyboard or a phone keypad. The EPG information is typically a markup-language, such as, e.g. XML. An application running on the STB may process this information and render it on a TV-screen connected to the STB.

In general, there are four communication means suitable for the communication between a receiver for IPTV, which from now on will be referred to as an IPTV Terminating function (ITF), such as, e.g. a STB/TV, and a network. FIG. 1a-d, schematically illustrates these four different ways of transmitting content.

FIG. 1a illustrates transmission via client specific streaming. Client specific streaming is a communication means which is suitable for delivery of audio and/or video to a specified end-user in real-time. Client specific streaming may be provided on the basis of the control protocol Real Time Streaming Protocol (RSTP) and the transport protocol Real-time Transport Protocol (RTP) and is typically used on demand. In figure la, three IPTV Terminating Functions (ITFs) 101-103 are connected to an Application Server Platform (ASP) 100, providing IPTV services to the ITFs. Each ITF, may request for delivery of different streamed content from the common ASP 100 on demand. ITF 1 101, receives required streamed content 104 from ASP 100 via client specific streaming, while ITF 2 102, receives streamed content 105, and ITF 3 103 receives a third stream of data content 106. Each stream illustrated in FIG. 1a is delivered via separate, independent streaming sessions.

Client specific pull is another communication means based on a functionality which enables a client to automatically request for data without having to rely on any user-intervention, i.e. data is delivered according to a predetermined specification. This communication means, which is presented in FIG. 1b, enables an ITF to automatically request for content without having to rely on any user-intervention, i.e. content is delivered according to a predetermined specification, which may be unique for each ITF. In the figure, ITF 1 101, ITF 2 102 and ITF 3 103, receives the respective content 104,105 and 106, independent from each other.

Client specific push is yet another communication alternative presented in FIG. 3c. Client specific push enables requested data to be automatically received from a server in accordance with predetermined rules or preferences stored at the servers. This communication alternative, however, rely on a server of the ASP, which independently may push data content to the different ITFs, wherein what content to deliver and when to deliver the respective content depends on specifications, previously made for the respective ITF.

In any broadband system there is frequently a need to send the same information to a large number of ITFs. Sending this information to each ITF individually is possible but not desirable due to a number of reasons. Initially, the information to be transmitted can be quite large in size and can require considerable bandwidth resources from the used access network. Secondly, the information may interfere with other real-time traffic, in the absence of traffic prioritization in the home network environment. Finally, the aggregated control traffic destined for all ITFs may cause potential congestion in the core network, impacting revenue generating traffic.

All three communication means mentioned above suffer from the drawbacks just mentioned. Therefore another means of communication will be required.

General specific push is a communication means for delivery of the same data content to a plurality of ITFs 101-103. In FIG. 1d, the architecture presented above is used for illustrating an exemplified general specific push data delivery. General push, which is an essential mechanism for reduction of response time and network load, relies on a

Multi-cast Data Channel (MDC) for the delivery of data content between an ASP 100 and connected ITFs 101-103. MDC is suitable for different types of information transfer, such as e.g. delivery of EPG web pages, metadata files, interactivity trigger files, firmware upgrades and alert messages.

In FIG. 1d, all three ITFs receive the same data content 104 simultaneously over the MDC.

From the operators point of view, however, the traditional IPTV EPG described above has some important drawbacks, also when used with general push, in that different STB manufacturers provide different user interfaces. This makes it more difficult for the operators to brand their IPTV service to the end-users. It also makes it more difficult to introduce new user interfaces and services. In addition, the possibilities for personalizing new applications are very limited.

Because of the drawbacks mentioned above, some new IPTV systems are considering a thin client concept, in which web-browser technologies, such as e.g. HTML, javascript or Scalable Vector Graphics (SVG) are used in order to obtain an operator branded, personalized web-type interface.

Still, one major drawback with a browser-type interface is, that it discloses an inherent drawback with client server technology, which means that a lot of users browsing the EPG concurrently may introduce a significant load on the servers and intermediate network.

### SUMMARY

It is an object of the present invention to address the problems outlined above. More specifically, it is an object of the present invention to find a mechanism which offers efficient transmission of IPTV content to a large number of subscribers. It is also desirable to obtain a more flexible mechanism for selective reception and handling of file content in receivers, such as, e.g. ITFs.

These objects and others can be obtained by providing a method, a receiver and a multi-cast controller according to the independent claims attached below.

According to one aspect, the present invention involves a method of file delivery to a plurality of receivers, listening to a multi-cast channel. The method includes receiving and queuing requests for file delivery from one or more Application Server Platforms (ASPs), at a Multi-Cast Controller (MCC), wherein each request comprises at least one attribute, specifying a condition for how to handle the request and associated file content. The method further includes the retrieving of file content from a respective ASP, upon having determined that the file content is to be delivered from the MCC to the receivers over a multi-cast channel. Each file delivery is then scheduled on the basis of the at least one attribute. File description information is formatted and transmitted in one or more file entries, each of which are associated with the file content. Next, the file content is formatted and delivering in one or more file instance.

Prior to receiving and queuing a request, the requested file content has been delivered from the respective ASP to the requesting receiver via uni-cast.

According to another aspect, the present invention also involves a method in a communication network for selectively receiving file content at a receiver, listening to a multi-cast channel. This method includes receiving one or more file entries on the multi-cast channel, where each file entry comprises one or more attributes and an identifier, linking the respective file entry to one or more file instances, wherein each file instance comprises file content and an identical identifier. File instances of interest to the receiver are identified by matching the one or more attributes of each file entry with one or more selection criteria, specifying reception requirements for the receiver. Next, file content is received in one or more file instances, wherein file instances of interest to the receiver are handled according to the one or more attributes, associated with the file instance, while remaining file instances are discarded.

The selection criteria may comprise one or more of: region, indicating the geographical region the receiver is located in; brand, indicating the manufacturer or the receiver; version, indicating the firmware of the receiver; interest, indicating areas of interest of the current user of the receiver; rating, indicating the minimum rating level of the current user of a receiver; age, indicating the minimum age of the current user of a receiver, or channel, indicating the TV channel that is currently watched on an receiver.

The method may further include an interrogation of a cache for required file content, wherein file content stored in the cache has been delivered to the receiver via multi-cast delivery, and wherein the file content is retrieved from the cache if the file content is stored in the cache. If, however the file content is not stored in the cache, the file content is retrieved from an ASP, via uni-cast delivery.

If the requested file content is not stored in the cache the request for uni-cast delivery is forwarded from the ASP to an MCC, in addition to initiating the uni-cast delivery. In the MCC it is determined whether the requested file content is to be delivered also on the multi-cast channel.

At the determination step, criteria, such as, e.g. experienced file request patterns and/or stored statistics of file delivery patterns may be considered.

Each file entry typically comprises the one or more attributes, retrieved from the respective request, and a unique identifier, which is linking the file entry to the respective one or more file instances, while the associated one or more file instances comprise file content and an identical identifier.

An identifying step may result in an updating of a selection list, comprising the identifiers of file instances of interest and the associated attributes, and wherein the selection list is used when filtering file instances, and when handling received file instances of interest.

An attribute, to be used according to any of the aspects mentioned above may, e.g., be one or more of: content-location, specifying a unique URL identification; content-type, specifying used information format; a priority, specifying the priority between file instances; criteria, specifying that a file instance needs to be processed; stale time, specifying the time before which a file instance must be sent on an MDC; validity time, specifying when a file instance becomes invalid, or type, specifying how a file instance should be handled.

The attribute “type” may, e.g., be one or more of the following: cache, indicating that a file instance is to be stored in an ITF cache; display, indicating that the content of a file instance is to be displayed on an ITF screen; upgrade, indicating that the content of a file instance is to be used for firmware upgrading; interactivity message, indicating that a file instance is to be used in an interactive session; join channel, indicating that a receiver should join another MDC channel, or leave channel, indicating that a receiver should leave the present MDC.

In one embodiment, the content of a file instance of interest may be associated with an attribute, indicating that the content is to be put in the cache of the receiver. In such a situation, the content is stored in the cache for a duration, specified in another associated attribute.

The multi-cast channel mentioned above may be a Multi-cast Data Channel (MDC), and the receiver may be an IPTV Terminating function (ITF).

Each receiver, used according to the embodiments mentioned above may also comprise a list of one or more predetermined selection criteria, wherein each selection criteria is specifying a rule for file content reception for the receiver.

According to another aspect, the present invention involves a receiver for selective reception of file content, delivered on a multi-cast channel. The receiver comprises means for joining the multi-cast channel, and means for receiving at least one file entry on the multi-cast channel, prior to receiving associated file content in at least one file instance. The receiver further comprises means for identifying file instances that are considered relevant for the receiver by filtering received file entries.

The means for identifying file instances may further be adapted to handle each file instance, carrying relevant file content, on the basis of one or more attributes, retrieved from the associated file entry.

In addition, the receiver may comprise means for interrogating a cache for required file content, wherein file content stored in the cache has been delivered to the receiver via multi-cast delivery. This means may also be adapted to retrieve the file content from the cache if it is stored in the cache, or to retrieve the file content from an ASP, via a uni-cast delivery, in case the file content is not stored in the cache.

In one aspect, the identifying means may be adapted to identify the one or more attributes and the identifier of each file entry, and to identify each one or more file instance, comprising file content which is linked to the file entry via an identical identifier.

In yet another aspect, the identifying means may be adapted to filter received file entries by matching the one or more attributes of each respective file entry with the one or more selection criteria, specifying reception requirements for the receiver.

In another aspect, the means for identifying file instances may further be adapted to update a selection list, comprising the identifiers of file instances of interest, and the associated attributes.

The receiving means may be adapted to use the selection list to accept file instances of interest and to discard remaining file instances, while the means for identifying file instances may be adapted to handle file instances of interest according to the associated one or more attributes.

In another aspect, the receiver may comprise means for inserting relevant file content in the cache if this is indicated with an attribute, or for replacing already existing file content with a new version of the file content.

The receiver, which may be an ITF, can be any of a Set-Top-Box/TV, a mobile telephone or personal computer (PC).

According to yet another aspect, the present invention involves an MCC for managing multi-cast delivery to a plurality of receivers, listening to a multi-cast channel, which is managed by the MCC. The MCC comprises means for receiving, and means for queuing file delivery requests from at least one SPP, wherein each request comprises one or more attributes, each specifying a condition for how to handle the request and the associated file content. The MCC also comprises means for determining whether a file content is to be delivered from the MCC to the receivers over a multi-cast channel. The MCC further comprises means for retrieving a file content to be delivered over the multi-cast channel, and means for scheduling each file delivery on the basis of the one or more attributes of the associated request. The MCC also comprises means for formatting and delivering file description information in one or more file entries, associated with the file content, prior to formatting and delivering the file content in one or more file instances.

The means for formatting and delivering may be adapted to format each file entry to comprise one or more attributes and a unique identifier, linking the file entry to a file instance, carrying associated file content, and to format the file instance to comprise the associated file content and an identical identifier.

In yet another aspect, the determining means is adapted to consider experienced file request patterns and/or stored statistics of file delivery patterns, when determining whether a file content is to be delivered from the MCC to the receivers over the multi-cast channel, which may be, e.g. an MDC.

Further features of the present invention and its benefits will be explained in the detailed description below.

### BRIEF DESCRIPTION OF THE DRAWINGS

The present invention will now be described in more detail with reference to the accompanying drawing, in which:

FIG. 1a is a schematic illustration of one way of providing file delivery between from a network to IPTV receivers based on client specific streaming, according to the prior art.

FIG. 1b is another schematic illustration of a second way of providing file delivery according to the prior art, wherein client specific pull is used for the file delivery.

FIG. 1c is yet another schematic illustration illustrating a third file delivery means, according to the prior art, using client specific push.

FIG. 1d is another schematic illustration, presenting a fourth alternative way of file delivery according to the prior art, which is based on general specific push.

FIG. 2 is an illustration of an exemplary FLUTE File Delivery Structure, according to the prior art.

FIG. 3a is a table, explaining the function of a number of exemplified attributes, and in which nodes the attribute are related when used in a method , according to one embodiment.

FIG. 3b is another table, explaining how some exemplified type attributes may be defined when used in a method, according to one embodiment.

FIG. 4 illustrates the architecture of a network and an IPTV Terminating Function (ITF), involved in a multi-cast delivery, according to embodiment.

FIG. 5 illustrates the architecture of a Multi-Cast Controller (MCC) in further detail, wherein the MCC controls multi-cast channel delivery, according to one embodiment.

FIG. 6 illustrates the architecture of a Multi-cast Data Channel Terminal Function (MDC TF) of an ITF in further detail, wherein the MDC TF receives and handles file objects received at the IFT, according to one embodiment.

FIG. 7 is yet another table presenting some exemplified selection criteria and how these can be defined when used in a method, according to a described embodiment.

FIG. 8 is a signalling chart illustrating a procedure for multi-cast file delivery, according to one embodiment.

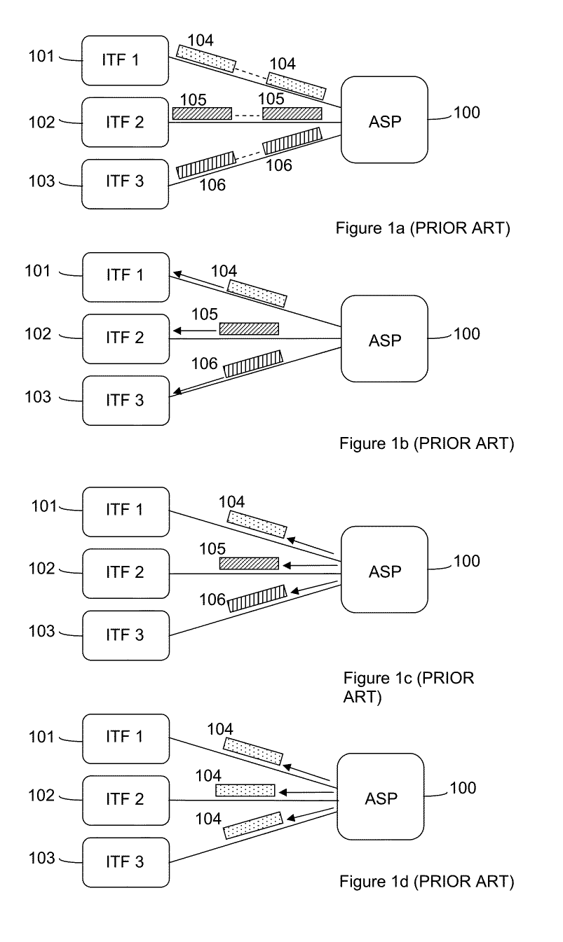

### DETAILED DESCRIPTION

Briefly described, the present invention provides a solution where a multicast channel, used for the delivery of application and media data, is combined with a client browser concept in order to obtain a flexible user interface, and an efficient delivery mechanism for IPTV services.

In order to provide an improved mechanism for the delivery of data content, particularly IPTV related data content, providing IPTV services to a number of receivers, referred to as IPTV Terminating functions (ITFs), it is suggested that the known technique based on transmission over a multi-cast channel, such as, e.g. an MDC, is further developed with the focus on providing more flexibility to the transmitting end, as well as on providing a selective reception mechanism, to be implemented at the receiving ends of a network.

A Multi-Cast File Delivery Protocol, denoted FLUTE, is a protocol that is the de-fact standard for delivery of files over a multi-cast, uni-directional channel. Even though it is not an official standard yet, it has been adopted in various contexts, such as, e.g. OMA BCast, 3GPP, and as the protocol of choice for multi-cast delivery of multimedia files. FLUTE is built on Asynchronous Layered Coding (ALC), version 1, which is the base protocol designed for massively scalable multicast distribution.

ALC, which defines transport of arbitrary binary objects, commonly refers to transferred data objects as objects, while FLUTE describes the data objects as files. For this reason the terms “object” and “file” will be used interchangeably throughout this document. It is also to be noted that the term “object” when used in this context denotes a transferred data item, instead of an object, as would normally be the case in an object oriented context.

For file delivery applications, mere transport of objects is, however, not enough. The end systems need to know what the objects actually represent. FLUTE specifies a mechanism for signalling and mapping the properties of files to concepts of ALC in a way that allows receivers to assign those parameters for received objects. For this reason, FLUTE defines a specific transport application of ALC, building a file delivery session, including transport details and timing constraints, on top of ALC. It also provides in-band signalling of the transport parameters of the ALC session, as well as in-band signalling of the properties of delivered files. In addition, FLUTE also specifies details associated with the multiplexing of multiple files within a session.

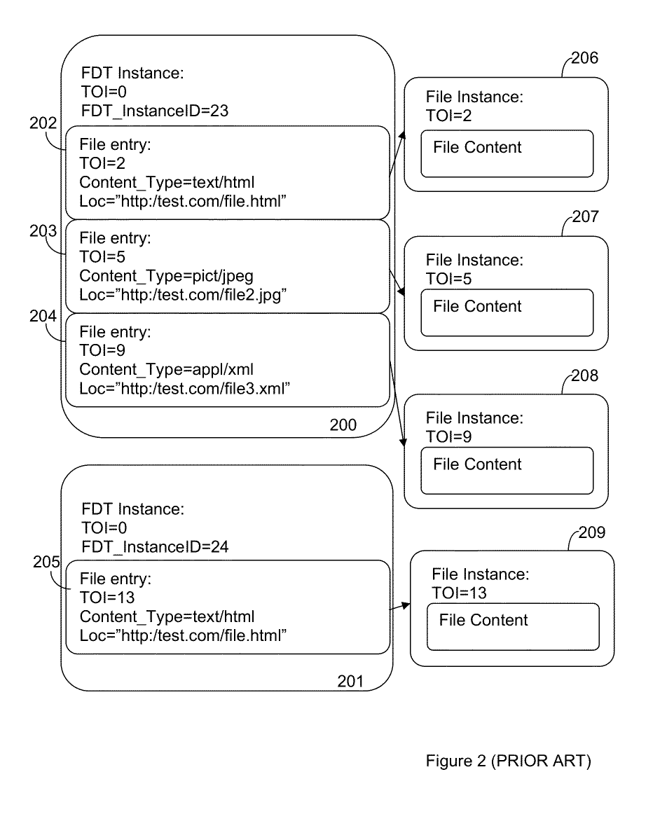

FLUTE provides for the delivery of file description information separated from the actual file content, where the file description information typically is delivered in a FILE Delivery Table (FDT). An FDT, comprising file description information of one or more files may be delivered as one single object (FDT instance), or spread over multiple FDT instances, and may, thus, be transmitted as a continuous stream of file descriptor instances. An example of such a prior art FLUTE File Delivery Structure is described with reference to FIG. 2.

FIG. 2 illustrates a typical content of two FDT instances 200 and 201, each tagged with an FDT instance identity (FDT_InstanceID). An FDT instance may comprise one or more file entries, each comprising information about associated file content, and an identifier, linking the file entry to the respective file content. In the figure, the first FDT instance 200, tagged with FDT instance ID 23, contains three file entries 202-204, while the second, subsequent FDT instance 201, tagged with FDT identity 24, only contains one single file entry 205. Each file entry 202-205 is associated with a file instance (file object) 206-209, carrying the file content, i.e. the user information to be delivered to a plurality of ITFs via a multi-cast channel. Each file entry 202-205 comprises one or more attributes, associated with, and indicating specific information on the associated file content. This information may be relevant for the reception mechanisms so that the respective file instances can be handled accordingly. A full list of attributes defined for FLUTE can be found in RFC 3926 “FLUTE—File Delivery over Unidirectional Transport”. The file entries presented in the figure comprises the two attributes “Content_Type” and “Content_Location” (Loc). Content_Type is an attribute indicating the MIME (Multipurpose Internet Mail Extensions) type, defined for the associated file content. As illustrated in the figure, Content_Type may be used to indicate the delivery of file content in the form of, e.g. an HTML text (text/html), a jpeg picture (pict/jpeg) or an xml application (appl/xml). Content_Location, which is mandatory for the FDT, is a URL descriptor that uniquely identifies the file and may contain an HTTP address, such as, e.g. “http:/test.com/file.html”. In addition, each file entry also contains a Target Object Identifier (TOI), which is a unique ALC-level identifier, indicating a link between a file entry of the FDT and the actual file content, i.e. FDT 202 with TOI set to 2 is the file descriptor for the file content carried in file instance 206, which is also tagged with a TOI that is set to 2. In order to be able to distinguish file description instances from file instances in a receiver, each file description instance (FDT instance) is provided with a TOI which equals 0, while file entries and linked file instances are provided with a unique TOI which equals a number other than 0.

By extending the FLUTE FDT, described above, and by using the attributes with an improved delivery mechanism, which may be implemented at the transmitting end of the multi-cast channel, a more effective mechanism for multi-cast delivery is required.

At each ITF listening to an MDC, a proposed filtering mechanism will also provide for selective reception and handling of delivered file content.

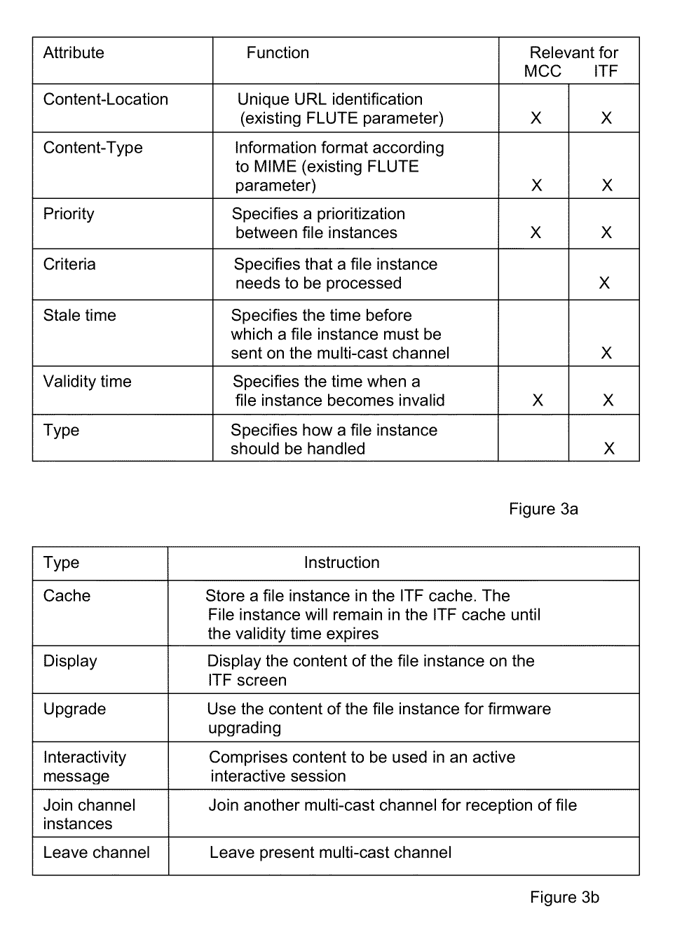

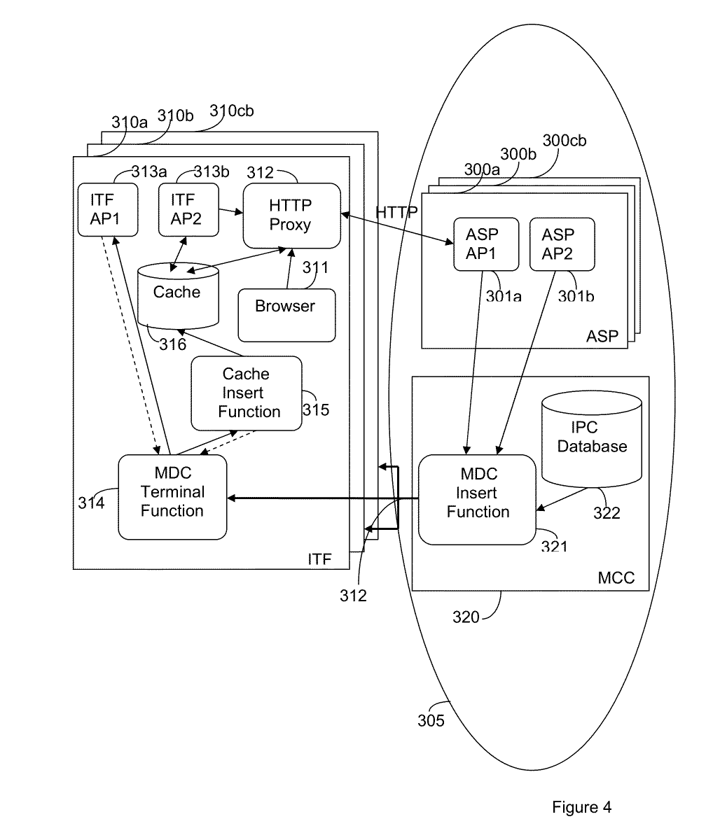

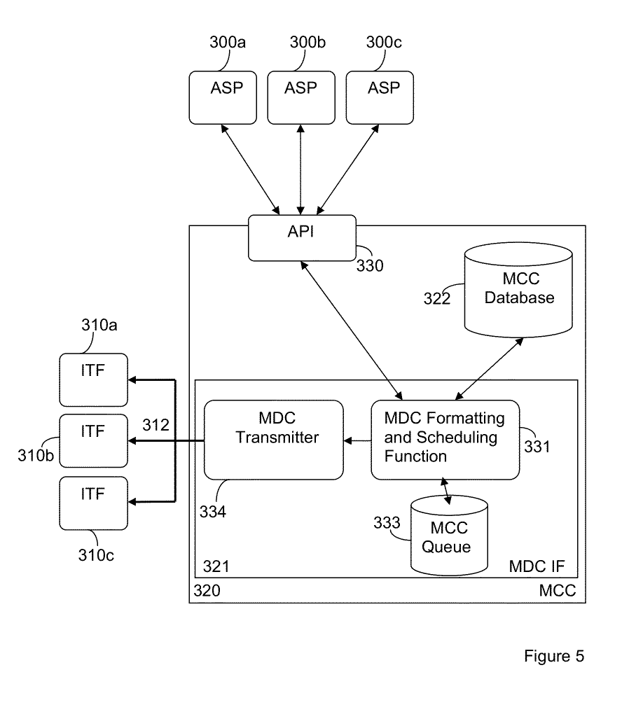

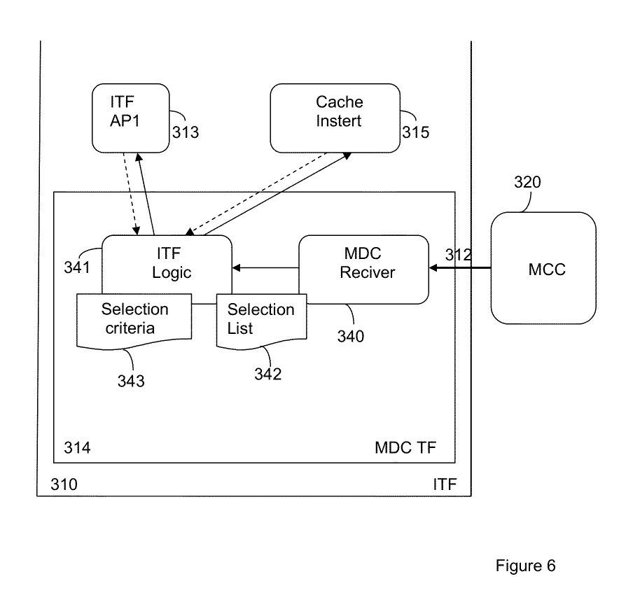

In FIG. 3a, a number of attributes which may be used in the proposed, extended FLUTE/FDT are presented. The main purpose with the enlarged list of attributes is to provide parameters enabling an improved delivery mechanism at the transmitting entity, and a selective mechanism to be used for filtering desired file content at the receiving ITFs. It is to be understood that the list of attributes presented in FIG. 3a is presented without any limitations, and that both the proposed delivery mechanism and selective mechanism are adapted to operate also with additional attributes, some of which may be operator specific. The delivery mechanism will be managed by an entity denoted the Multi-Cast Controller (MCC), which will be described in further detail below with reference to FIGS. 4 and 5, while the selective mechanism will be managed by an MDC Terminal Function (MDC TF). The MDC TF will be described in more detail with reference to FIG. 6.

The two attributes “Content-Location” and “Content-Type” represents already existing FLUTE attributes. “Priority” is an attribute which may be relevant both in the transmitting- and receiving phase. This attribute may be used in the scheduling, when prioritizing between objects about to be delivered over an MDC, which is congested or about to become congested. In the IFT this attribute may be used to prioritize how to handle file content if congestion problems are about to occur in the ITF. “Criteria” is an attribute which may be of interest to the ITFs, indicating whether a received object matching a specific criteria needs to be processed or not.

The attribute “Stale time”, which may be relevant for the IFT, enables the MCC to delay transmission of an object, favouring other, more time critical deliveries. Stale time, thus, enables the MCC to use the MDC more efficiently.

“Validity time” is another proposed attribute, which may be relevant for both the MCC and for the ITFs. Validity time indicates how long the content of an object is valid, and, thus, how long the content of the object will be accessible, once delivered and stored in an IFT.

The “Type” attribute indicates how a message is to be handled by the respective ITF. Without any limitation, a list of possible type definitions is presented in FIG. 3b.

An object having the type, “Cache” indicates that the object is to be stored in a cache of the respective ITF. The cache is a storing means for storing and providing content requested for when browsing the IFT, or from an application of the IFT. File content which most likely will be requested for in the near future, e.g. because of its popularity, may be delivered in advance and stored in the cache for fast retrieval when required. When browsing for content which has already been stored in the cache, a uni-cast delivery from an application server is, thus, avoided. The fact that this file content is delivered to a plurality of receivers over a multi-cast channels and stored in the cache of the respective receiver, before it is actually needed, thus, will save bandwidth. Another benefit will be that a user will be able to get faster access to file content. The function of the cache will be further described below with reference to FIG. 4.

Another type, denoted “Display” may be used to indicate that the respective content of a received object is to be displayed on the screen of the ITF. The “Upgrade” type is another type, which may be used to indicate to an ITF that the content of a respective object is to be used for firmware upgrading. “Interactivity message” is yet another attribute which may be used to indicate that the message is to be used in an interactivity session, while the two types “Join channel” and “Leave channel”, indicate to an ITF that it should join another MDC, or that it should leave the present MDC, respectively.

A schematic IPTV architecture based on an extended MDC/FLUTE concept, and a new criteria mechanism, according to one embodiment will now be described with reference to FIG. 4. The figure shows a communication network 305, comprising three IPTV Application Platforms (ASPs) 300a-c, each adapted to provide file content, associated with IPTV services, to one or more of three ITFs 310a-c, which may be any of, e.g. an STB/TV, a PC or a cellular telephone, adapted to receive IPTV services. For reasons of clarity, although the ITFs and ASPs are limited to three entities in the figure, the architecture could, easily be extended with additional ITSs and ASPs. The communication network 305, also comprises an introduced Multi-Cast Controller (MCC) 320, adapted to control multi-cast delivery of file content to the ITFs listening to the MDC.

Each ASP 300a-c may comprise one or more applications (ASP AP 1, ASP AP2) 301a,301b, each adapted to provide specific IPTV services to subscribing end-users, using any of the ITFs 310a-c. Some applications (ASP AP1) 301a may be adapted to provide services in response to a user interaction, such as, e.g. browsing, or in response to an automated request, initiated by an application of the ITF. Normally, a request for a file is sent to the respective ASP, from where the requested file content is delivered to the ITF via uni-cast. According to the described embodiment, requests for file delivery are also sent to the MCC from the one or more ASPs, in addition to triggering a uni-cast file delivery. In the MCC, received requests are evaluated, considering, e.g. experienced file request patterns or stored statistics of file delivery patterns, for determining whether a file should also be delivered to, and stored in the IFTs, listening to a multi-cast channel. Once delivered to an IFT, this file content will be retrievable by the IFT immediately upon request, without having to burden the communication network 305 with any signalling.

Other applications (ASP AP2) 301b may be adapted to execute a request for a direct multi-cast file delivery on the basis of some other trigger, initiated internally or externally. Services not requiring any user-interaction may comprise, e.g. the distribution of emergency information to be delivered to a group of ITFs in case of an emergency situation.

It is to be understood that the ITFs presented in this document also are supposed to be equipped with necessary interaction functionality, such as a display, necessary for presenting the retrieved content to an end-user, and a user interface, adapted for insertion of user specific options, as well as for executing user-interaction, associated with interactive IPTV services. This type of functionality is, however, commonly known and offered in various alternatives on the market, and, thus, out of scope of this document.

From an IFTs perspective, file content which is of interest to a user is normally requested from a respective ASP 300a-c by user interaction, wherein an end-user browsing with a browser 311 of the respective ITF 310a-c, can access an ASP and retrieve the requested file through uni-cast delivery, via a HTTP proxy 312. Alternatively, an application (IFT AP2) 313b of the ITF may trigger the HTTP proxy 312 to request for a required file automatically.

According to the presented embodiment, however, a requested file is initially searched for in a cache 316 of the respective ITF. The cache 316 contains file content that has been retrieved from the MCC over an MDC, prior to the search, wherein the respective file content is maintained in the cache 316 as long as it is set to be valid. The validity of a file may be defined by a specific validity attribute, stored in association with the content. If the requested file content is found in the cache 316, it can be retrieved without any further delay and without having to initiate any request for file delivery over the communication network 305. If, however, the file is not present in the cache, a request for a uni-cast file delivery has to be initiated and forwarded to the respective ASP and application. One or more attributes, each defining a file specific requirement, are attached to the request before it is delivered to one of the ASPs 300a-c.

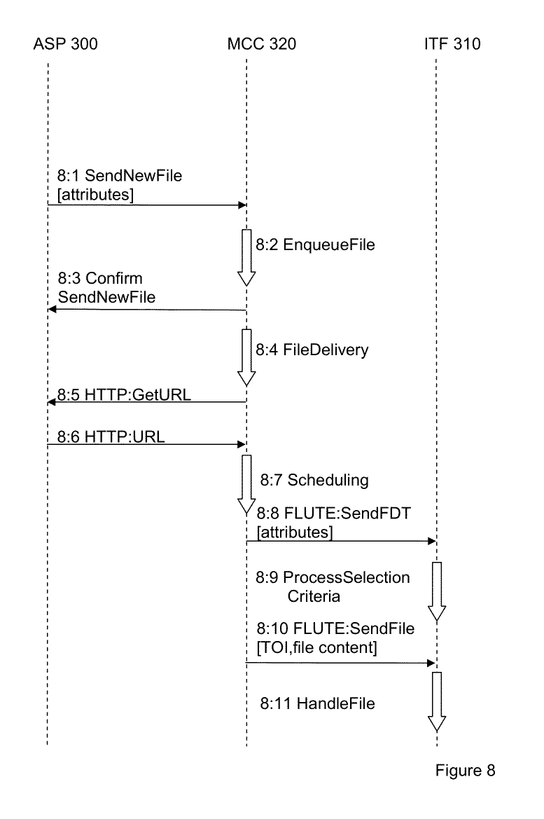

In order to provide an improved MDC delivery mechanism, control functionality on the transmitting side of an MDC 312 will be required. For this reason, the generic controlling function, denoted as the Multi-Cast Controller (MCC) 320, is introduced. As mentioned above, each uni-cast request forwarded to an ASP will also be forwarded to the MCC 320, where the request is evaluated together with other requests and, based on available information, a determination is made whether the file content should also be delivered over MDC 312. An example of such a process will be described below with reference to FIG. 8.

MCC 320 is responsible for a multi-cast delivery of file content, provided from the ASPs 300a-c on an MDC 312, to every ITF 310a-c that has joined, and is listening to the MDC 312. Although, only one MDC 312 is illustrated in the figure, an MCC may be able to control file deliveries over a plurality of MDCs. An IFT normally joins an MDC at start-up, typically by using the Internet Group Management Protocol (IGMP), and keeps listening to the MDC until the IFT is powered off, or until it is instructed to change MDC.

The MCC 320 may also be connected to one or more MDC Proxies (not shown), operating as an intermediate unit between an ITF 310a-c and an ASP 300a-c.

The MDC Insert Function (MDC IF) 321, which will be described in more detail below with reference to FIG. 5, is adapted to control the multi-cast file delivery of file content, retrieved from an ASP 300a,b,c. Upon having come to the conclusion that a file is to be delivered over the MDC 312, the actual file content is retrieved from the respective ASP. A file content delivery is then scheduled and pushed to the ITFs 310a-c. Efficient delivery management for the respective MDC 312 will rely on a scheduling scheme, which will take content specific criteria into consideration. The proposed extended FDT, used with a filtering process, will introduce a more flexible scheduling, wherein the one or more attributes received in the requests, and, optionally, additional information, such as, e.g., TV program popularity statistics, stored in an MCC database (MCC DB) 322, may be considered during the determining procedure. Typically, the MCC DB 322 also maintains various carousels of file instances to be repeated on the MDC with regular intervals.

Once delivered to an ITF 310a via MDC 312, the file content will be handled by an introduced MDC Terminal Function (MDC TF) 314. A proposed filtering process may be controlled by logic located in MDC TF 314, or by an application (IFT AP1) 313a of the ITF 310a-c. The filtering process allows an end-user to distinguish received file content that is of interest to the end-user from irrelevant content. After filtering, identified file content is handled according to one or more attributes associated with the file content. File content may, e.g. be retrieved from the MDC TF 314 by a Cache Insert Function (Cache IF) 315, and inserted into the cache 316, if indicated by a respective attribute. The respective file content normally remains in the cache as long as it is valid. When the validity time, which may be set by a validity attribute expires, the file content is discarded from the cache 316. If, however, a corresponding file is already present in the cache, this file is discarded and replaced with the new, updated one.

An exemplary MCC 320, comprising the MDC IF 321 to be used for multi-cast delivery evaluation and scheduling according to the embodiment described above will now be presented in more detail with reference to FIG. 5.

MCC 320 comprises one or more Application Programming Interfaces (APIs) 330, applied towards the applications of the ASPs 300a-c, allowing reception of requests, originally destined for an ASP 300a,b,c, as well as allowing reception of the file content itself, once a decision for multi-cast file delivery of the respective file content has been made by the MCC 320. A request for a file delivery received by the API 330 is forwarded to the MDC Formatting and Scheduling Function (MDC FSF) 331, where the request is put in a queue 333, together with other queuing requests. Subsequent to the queuing, the MDC FSF 331 may use statistics stored in, and retrieved from MCC DB 322, to determine if the file is to be delivered also over the MDC. If this is decided, the file content is retrieved from the respective ASP, typically by executing a client specific PULL, and the file delivery is scheduled on the basis of one or more attributes retrieved in the request.

The scheduling may be based on one or more filtering functions, to be activated alone or in a combination. On a first level, which may be activated when an MDC has reached a predetermined bandwidth limit, the MDC FSF 331 may consider an attribute, such as, e.g. priority, in order to prioritize the order in which to execute the requested file delivery. On a second level, which is considered when the risk of congestion on the MDC is low, other attributes, such as e.g. stale time and/or validity time may be considered and compared to corresponding attributes of other requests.

In addition to the attributes, also the scheduling may use information retrieved from the MCC DB 322 such as, e.g. the most frequently requested file content is dedicated the highest priority.

Subsequent to the scheduling, the file content and file description information, comprising instructions for the receivers of the IFTs, is formatted in the MDC FSF 321 according to the FLUTE protocol.

As described above, with reference to FIG. 2, one or more file description instances are assembled as FDT instances, each of which are carrying one or more file entries. The FDT instances are pushed to the ITFs 310a-c on a dedicated MDC, via an MDC Transmitter 334. Once the FDT instances, have been delivered to the IFTs, one or more ALC packets, carrying the file content are assembled together with the relevant identifier (TOI). Also the ALC packets are then pushed to the ITSs 310a-c via the MDC transmitter 334.

In each receiving IFT, file content of interest can be identified and distinguished from irrelevant content, using the attributes associated with the file content and a selection criteria, defining a specific profile set for each receiver. An exemplary MDC TF 314 of an ITF 310, adapted to control such identification and filtering according to the described embodiment will now be presented in more detail with reference to FIG. 6.

File entries arriving at the MDC TF 314, via an MDC are received by an MDC receiver 340, and handled by ITF logic 341. The ITF logic 341 comprises an identifying mechanism, which is used for determining whether the file content to be delivered subsequent to the file entries, is of interest to the ITF. After having compared the attributes of the file instances with a preset selection criteria 343, retrieved from the IFT logic 341 or IFT AP1 313, the ITF logic puts together a selection list 342, indicating the one or more identifiers (TOIs) that are linking to the file instances which have been found to be of interest for the ITF, and the associated attributes. All file instances, comprising an identifier that is present in the selection list 342 are considered by the IFT logic 341 and handled according to the respective one or more attributes. File instances having an identifier that is not present in the selection list 342, however, are discarded by the IFT Logic 341. In an alternative embodiment, irrelevant file content may be discarded already in the MDC receiver 340.

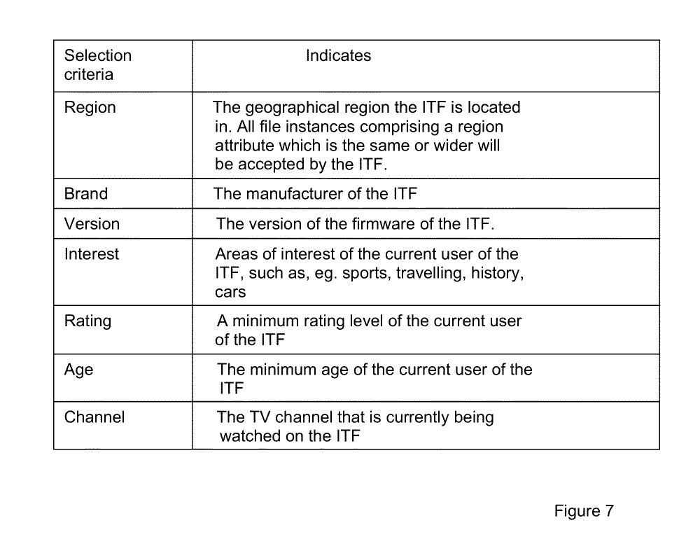

FIG. 7 presents some examples of selection criteria, which may be used to specify reception requirements for an ITF, i.e. to personalize the reception.

Selection criteria “Region” defines the geographical region the respective IFT is located in. When using the selection criteria “Region”, an ITF that is located in the zone defined with e.g. “se.stockholm.norrmalm.se” will accept all arriving file instances tagged with region “se”, “se.stockholm”, and “se.stockholm.norrmalm”.

Selection criteria “Brand” indicates the manufacturer of the ITF. This criteria may indicate that only content intended for that specific brand should be accepted.

“Version” is another selection criteria, which may be used to indicate which firmware version that is used, enabling the ITF to filter out any content which is not adapted to be used with this version.

“Interest” may provide an end-user with a great variety of alternative options to be used to personalize an IFT and, thus, to selectively be able to choose which categories of content to receive, via the proposed MDC mechanism.

“Rating” may be used to indicate a minimum level of the current users of the ITF.

“Age” may indicate the minimum age of the current user of the ITF, while “Channel” is a selection criteria indicating the TV channel that is currently being watched on the ITF.

It is to be understood that this presented list of selection criteria only describe the principle use by way of examples. The list of FIG. 7 could, thus, be extended with additional selection criteria suitable for expressing aspects of interests and preferences from end-users, as well as from a manufacturers and/or a service providers point of view.

The ITF logic 341 is also adapted to handle file instances of interest according to the type attribute. A file instance, being marked with cache will for example be forwarded to and stored in the cache 315, as explained above. If, however, the cache is full or has reached a predetermined threshold, a priority attribute may be used to determine which file instances to prioritize.

FIG. 8 is a signalling diagram, illustrating the file delivery mechanism according to the embodiment described above. In FIG. 8 it is illustrated how a request for a file delivered to an ASP 300 is forwarded to an MCC 320, and how a determination to send the requested file content also to a group of IFTs, via an MDC, is made in the MCC, according to an embodiment described above. It is to be understood that although the signalling diagram in FIG. 8 only shows the arrival of one request, a decision for a multi-cast file delivery will only be made if a plurality of requests for the same file indicates some kind of pattern to the decision logic of the MCC 320.

In a first step 8:1 (ReqNewFile[attributes]) of FIG. 8, one of a number of requests for file delivery, initially forwarded from an IFT to an ASP 300, is forwarded from the ASP 300 to the MCC 320. In the ITF, each request has initially been provided with attributes indicating certain requirements for the respective requested file. In a next step 8:2, the request is put in a queue (EnqueueFile), together with other requests, received from the same, or other ASPs. The queuing of the request is confirmed to the ASP 300 (ConfirmSendNewFile) in a subsequent step 8:3. In another step 8:4, decision logic determines whether the file content is to be delivered via multi-cast delivery by the MCC 320. If multi-cast delivery is decided for a file, that file content is pulled (HTTP:GetURL) from the ASP 300 in a step 8:5, and a step 8:6 (HTTP:URL). Next the multi-cast file delivery is scheduled, whereby different criteria may be used in order to, e.g. avoid congestion on the MDC and/or to prioritize deliveries in an efficient way. The scheduling, which is illustrated with a step 8:7, typically relies on the attributes, delivered with the respective requests, but may also rely on additional statistics relevant for the file content to be delivered. The retrieved file content is now available at the MCC 320 for delivery to all ITFs listening to the MDC. In a step 8:8, one or more FDT instances, associated with the file content to be transmitted, are assembled and pushed (FLUTE:SendFDT [attributes]) to the ITFs listening to the respective multi-cast channel. Once received at an ITF 310, the one or more attributes of the FDT instances are used for filtering (ProcessSelectionCriteria) the file content which is considered relevant for the IFT 310 by matching the one or more attributes with the selection criteria of the IFT 310. This is done in another step 8:9. As a result from the matching, the file instances considered as relevant for the IFT 310 can be distinguished from the file instances found irrelevant for the receiver. In a next step 8:10, the file instances associated with the previously pushed DFT instances are pushed (FLUTE: SendFile[TOI,file content]) to the ITFs via the dedicated MDC. Depending on the result from the filtering procedure, the relevant file content can now be handled accordingly. In the figure this step is indicated with a step 8:11 (HandleFile).

While the invention has been described with reference to specific exemplary embodiments, the description is generally only intended to illustrate the inventive concept and should not be taken as limiting the scope of the invention, which is defined by the appended claims.

1. A method in a communication network for file delivery to a plurality of receivers listening to a multi-cast channel comprising:
receiving and queuing requests for the file delivery from at least one Application Server Platform (ASP) at a Multi-Cast Controller (MCC), wherein each request comprises at least one attribute specifying a condition for how to handle the request and associated file content;
retrieving file content from a respective ASP upon having determined that the file content is to be delivered from the MCC to the receivers over the multi-cast channel;
scheduling each file delivery on a basis of the at least one attribute; and
formatting and delivering file description information in at least one file entry, associated with the file content, prior to formatting and delivering the file content in at least one file instance.

2. A method according to claim 1, wherein prior to receiving and queuing a request, the requested file content has been delivered from the respective ASP to the requesting receiver via uni-cast.

3. A method in a communication network for selectively receiving file content at a receiver listening to a multi-cast channel, comprising:
receiving at least one file entry each comprising at least one attribute and an identifier linking the respective file entry to at least one file instance comprising file content and an identical identifier on the multi-cast channel;
identifying file instances of interest to the receiver by matching the at least one attribute of each file entry with at least one selection criteria specifying reception requirements for the receiver;
receiving the file content in at least one file instance on the multi-cast channel; and
handling file instances of interest to the receiver according to the at least one attribute associated with the file instance.

4. A method according to claim 3, wherein the selection criteria can comprise at least any of the following criteria:
region, indicating the geographical region the receiver is located in;
brand, indicating the manufacturer or the receiver;
version, indicating the firmware of the receiver;
interest, indicating areas of interest of the current user of the receiver;
rating, indicating the minimum rating level of the current user of a receiver;
age, indicating the minimum age of the current user of a receiver; and
channel, indicating the TV channel that is currently watched on an receiver.

5. The method according to claim 3, further comprising:
interrogating a cache for required file content, wherein file content stored in the cache has been delivered to the receiver via multi-cast delivery;
retrieving the file content from the cache if the file content is stored in the cache; or
retrieving the file content from an Application Server Platform (ASP) via uni-cast delivery if the file content is not stored in the cache.

6. The method according to claim 5, wherein if the requested file content is not stored in the cache the request for uni-cast delivery is forwarded from the ASP to a Multi-Cast Controller (MCC) in addition to initiating the uni-cast delivery for determined whether the requested file content is to be delivered also on the multi-cast channel.

7. The method according to claim 1, wherein at the determining step one or both of the following criteria is considered:
experienced file request patterns; and
stored statistics of file delivery patterns.

8. The method according to claim 3, wherein each file entry comprises the at least one attribute retrieved from the respective request, and a unique identifier, linking the file entry to the respective at least one file instance, and wherein the associated file instance comprises file content and an identical identifier.

9. The method according to claim 3, wherein an identifying step results in an updating of a selection list comprising the identifiers of file instances of interest and the associated attributes and wherein the selection list is used when filtering file instances and when handling received file instances of interest.

10. The method according to claim 3, wherein an attribute can be at least any of the following:
content-location, specifying a unique URL identification;
content-type, specifying used information format;
a priority, specifying the priority between file instances;
criteria, specifying that a file instance needs to be processed;
stale time, specifying the time before which a file instance must be sent on a Multi-case Data Channel (MDC);
validity time, specifying when a file instance becomes invalid; and
type, specifying how a file instance should be handled.

11. The method according to claim 10, wherein a type attribute can be at least any of the following:
cache, indicating that a file instance is to be stored in an IPTV Terminating function (ITF) cache;
display, indicating that the content of a file instance is to be displayed on an ITF screen;
upgrade, indicating that the content of a file instance is to be used for firmware upgrading;
interactivity message, indicating that a file instance is to be used in an interactive session;
join channel, indicating that a receiver should join another MDC channel; and
leave channel, indicating that a receiver should leave the present MDC.

12. The method according to claim 3, wherein the content of a file instance of interest being associated with an attribute indicating that the content is to be put in the cache of the receiver is stored in the cache for a duration specified in another associated attribute.

13. A method according to any of the preceding claims, wherein the multi-cast channel is a Multi-cast Data Channel (MDC).

14. The method according to claim 3, wherein the receiver is an IPTV Terminating function (ITF).

15. The method according to claim 3, wherein each receiver comprises a list of one or more predetermined selection criteria, each specifying a rule for file content reception for the receiver.

16. A receiver for selective reception of file content delivered on a multi-cast channel, comprising:
means for joining the multi-cast channel;
means for receiving at least one file entry on the multi-cast channel prior to receiving associated file content in at least one file instance; and
means for identifying file instances that are considered relevant for the receiver by filtering received file entries.

17. The receiver according to claim 16, wherein the means for identifying file instances further is adapted to handle each file instance carrying relevant file content, on the basis of at least one attribute retrieved from the associated file entry.

18. The receiver according to claim 17, further comprising:
means for interrogating a cache for required file content, wherein file content stored in the cache has been delivered to the receiver via multi-cast delivery, wherein the means is adapted to retrieve the file content from the cache if it is stored in the cache, or to retrieve the file content from an Application Server Platform (ASP) via a uni-cast delivery if the file content is not stored in the cache.

19. The receiver according to claim 16, wherein the identifying means is adapted to identify the at least one attribute and the identifier of each received file entry and to identify each at least one file instance comprising file content which is linked to the file entry via an identical identifier.

20. The receiver according to claim 16, wherein the identifying means is adapted to filter received file entries by matching the at least one attribute of each respective file entry with at least one selection criteria specifying reception requirements for the receiver.

21. The receiver according to claim 16, wherein the means for identifying file instances is further adapted to update a selection list comprising the identifiers of file instances of interest and the associated attributes.

22. The receiver according to claim 21, wherein the receiving means is adapted to use the selection list to accept file instances of interest and to discard remaining file instances, and the means for identifying file instances is adapted to use the selection list for handling file instances of interest according to the associated at least one attribute.

23. The receiver according to claim 16, wherein the receiver further comprises:
means for inserting relevant file content associated with an attribute indicating so in the cache or for replacing already existing file content with a new version of the file content.

24. The receiver according to claim 16, wherein the receiver is an IPTV Terminating Function (ITF).

25. The receiver according to claim 16, wherein the ITF is any of a Set-Top-Box/TV, a mobile telephone or personal computer (PC).

26. A multi-cast controller (MCC) for managing multi-cast delivery to a plurality of receivers listening to a multi-cast channel managed by the MCC, comprising:
means for receiving and queuing file delivery requests from at least one Service Provider Platform (SPP), wherein each request comprises at least one attribute each specifying a condition for how to handle the request and the associated file content;
means for determining whether a file content is to be delivered from the MCC to the receivers over a multi-cast channel;
means for retrieving a file content to be delivered over the multi-cast channel;
means for scheduling each file delivery on a basis of the at least one attribute of the associated request; and
means for formatting and delivering file description information in at least one file entry associated with the file content, prior to formatting and delivering the file content in at least one file instance.

27. The multi-cast controller according to claim 26, wherein the formatting and delivering means is adapted to format each file entry to comprise at least one attribute and a unique identifier linking the file entry to a file instance carrying associated file content and to format the file instance to comprise the associated file content and an identical identifier.

28. The multi-cast controller according to claim 26, wherein the determining means is further adapted to consider one or both of the following criteria:
experienced file request patterns; and
stored statistics of file delivery patterns.

29. The multi-cast controller according to claim 26, wherein the multi-cast channel is a Multi-cast Data Channel (MDC).
